(19) United States
(12) Patent Application Publication
(10) Pub. No.: US 2022/0018804 A1
(43) Pub. Date: Jan. 20, 2022

(54) GAS SENSOR AND METHOD FOR MANUFACTURING SAME

(71) Applicant: KOA CORPORATION, INA-SHI, NAGANO (JP)

(72) Inventor: Tetsuro TANAKA, INA-SHI (JP)

(21) Appl. No.: 17/293,604

(22) PCT Filed: Nov. 27, 2019
(86) PCT No.: PCT/JP2019/046307

§ 371 Date: May 13, 2021

(30) Foreign Application Priority Data
Nov. 29, 2018 (JP) 2018-224287

(51) Int. Cl. G01N 27/407; G01N 27/409; G01N 27/12; G01N 27/14

(52) U.S. Cl. CPC G01N 27/4078; G01N 27/14; G01N 27/125; G01N 27/409

(57) ABSTRACT

An oxygen sensor is provided in which an insulative coating using an exterior resin material made of insulative resin is applied to a self-heating oxygen sensor element made of a ceramic sintered body housed in a case, and in which waterproof cloths with air permeability are attached using resin adhesives so as to cover openings that connect to air holes on end parts of the case. This allows provision of a gas sensor for use both in air and in liquid having insulating property, waterproof property, and thermal safety.

### TECHNICAL FIELD

The present invention relates to a gas sensor, which detects, for example, oxygen concentration etc. within a measurement atmosphere, and a manufacturing method thereof.

### BACKGROUND ART

Conventionally, there has been demand for oxygen concentration detection in various aspects, such as detection of oxygen concentration in exhaust gas of internal-combustion engines, etc., detection of oxygen concentration for boiler combustion control, and detection of oxygen concentration for prevention of indoor oxygen deficiency. As oxygen concentration detecting methods, a Galvanic cell-type, a zirconia solid electrolyte system, a magnetic type, a variable wavelength semiconductor laser spectroscopy type etc. are well known.

The Galvanic cell-type oxygen sensor, as described in Patent Document 1, for example, finds oxygen concentration by placing an anode made of a base metal, such as tin (Pb), and a cathode made of a precious metal, such as gold (Au), in a container filled with an electrolyte, isolating them from the outside using a gas-permeable diaphragm, and measuring electric current, which flows proportionately to oxygen concentration due to a chemical reaction caused by the oxygen dissolving in the electrolyte after having passed through the diaphragm.

Since the Galvanic cell-type oxygen sensor is small, light, operates at normal temperature, and is also inexpensive, it is used in a wide range of fields, such as checking oxygen deficiency in the hold of a ship or manhole, detection of oxygen concentration in medical equipment, such as anesthetic apparatus, artificial respirators, etc.

On the other hand, as an oxygen sensor for detecting oxygen concentration using a different method from the detecting method with electrolyte etc. described above, structures having as a sensing element an oxide superconductor including a rare earth element provided in a tube through which a gas to be measured flows, so as to detect oxygen concentration in the gas by an electric current flowing through the sensing element are disclosed in Patent Documents 2 and 3.

### PRIOR ART DOCUMENTS

### Patent Documents

Patent Document 1: JP 2015-34819A
Patent Document 2: JP 2007-85816 A (U.S. Pat. No. 4,714,867)
Patent Document 3: JP 2018-13403 A

### DISCLOSURE OF THE INVENTION

### Problems to be Solved by the Invention

Since a Galvanic cell-type oxygen concentration meter (oxygen sensor) can further downsize its own detecting part than the other types of oxygen concentration meters described above, it can be used as a mobile and portable oxygen sensor. On the other hand, even though it is relatively inexpensive compared to the other types, the Galvanic cell-type oxygen sensor requires regular exchange of consumed electrolyte and soiled diaphragm due to the structure by which oxygen is dissolved in the electrolyte via the diaphragm, and thus toxic electrolyte may leak into the environment when an abnormality occurs etc.

The oxygen sensor comprised of an oxide superconductor mentioned above functions as an oxygen sensor by applying a constant voltage to either end of a sensing element so as to generate a hot spot, and measuring value of an electric current that flows through the sensing element and changes according to the surrounding oxygen concentration. This oxygen sensor has a structure allowing further downsizing of the detection part, and may thus be made mobile and portable, but cannot be operated in liquid (water).

In further detail, the oxygen sensor comprised of an oxide superconductor is installed such that the sensing element floats inside of a heat-resistant glass tube so as to protect peripheral equipment from heat of the hot spot, which has a high temperature, and physically and electrically connected to metal external electrodes (cap terminals) provided on either end of the sensing element as a result of conductive wires extending from electrodes on either end of the sensing element. The oxygen sensor comprised of an oxide superconductor has air holes formed in the metal electrode parts in order to have a gas to be measured make contact with the hot spot or oxygen sensitive section.

The oxygen sensor having such a structure has problems that liquid such as rain easily enters from the air holes, and use in an environment needing a waterproof construction such as outdoor use is impossible, thereby limiting application as an oxygen sensor. Moreover, there is a problem that since the metal external electrodes are exposed, correct sensor output cannot be obtained due to leakage of an electric current flowing through the oxygen sensor between the external electrodes in a conductive material or liquid such as sea water, concrete, or a culture solution.

In light of these problems, the present invention aims to provide a gas sensor having insulating property and waterproof property, and a manufacturing method thereof.

### Means of Solving the Problems

A means for achieving the above aim and resolving the above problems includes the following structure. That is, a gas sensor of the present invention is characterized by including: a gas sensor element housed in a case having air holes; an insulative exterior member sealing the case while having openings that communicate with the air holes; a filter member arranged so as to cover the entire openings; and paired lead wires, which are connected to end part electrodes of the gas sensor element and lead outside the exterior member. A predetermined gas permeating through the filter member is detected by the gas sensor element.

For example, it is characterized in that the filter member is a permeable film that prevents a specified gas from permeating through. For example, it is characterized in that the filter member is a permeable waterproof film. For example, it is characterized in that the gas sensor element is a self-heating sensor element made of a ceramic sintered body. For example, it is characterized in that the exterior member is a urethane resin material. For example, it is characterized in that the filter member is attached using a urethane resin adhesive that is applied to circumferential edges of the openings. For example, it is characterized in that the exterior member is formed so as to cover at least electrodes provided on the end parts of the case. For example, it is characterized by further including a structure in which a first layer of the exterior member made of the urethane resin material, and a second layer made of the urethane resin adhesive are provided between the electrodes and the filter member.

Moreover, the present invention is characterized by a manufacturing method of a gas sensor housing a gas sensor element in a case having air holes, the method including the steps of: closing the air holes using plug members; sealing the case, which includes the closed air holes, with an insulative exterior member; removing the plug members from the air holes once the exterior member is hardened; and attaching filter members so as to cover entire openings that communicate with the air holes formed in portions where the plug members have been removed.

For example, it is characterized in that the exterior member is formed so as to cover at least electrodes provided on end parts of the case.

### Results of the Invention

According to the present invention, a gas sensor for use both in air and in liquid that is operatable in conductive solutions and conductive materials, and a manufacturing method thereof may be provided.

### BRIEF DESCRIPTION OF DRAWINGS

FIG. 1 is an external perspective view of a gas sensor according to an embodiment of the present invention;

FIG. 2 is a cross-section of the gas sensor of FIG. 1 when cut along a line indicated by arrows A-A′;

FIG. 3 is an external perspective view of an oxygen sensor configuring the gas sensor;

FIG. 4 is a flowchart showing manufacturing steps of an oxygen sensor element in time series;

FIG. 5 is a flowchart showing, in time series, the steps of manufacturing the oxygen sensor using the oxygen sensor element;

FIG. 6 is a flowchart showing manufacturing steps of the gas sensor according to the embodiment in time series;

FIGS. 7A and 7B show diagrams for explaining the manufacturing steps of the gas sensor;

FIGS. 8 A and 8B show diagrams for explaining the manufacturing steps of the gas sensor;

FIG. 9 is a diagram for explaining a gas sensor according to Modified Example 1;

FIG. 10 is an external perspective view of a gas sensor according to Modified Example 3;

FIG. 11 is an external perspective view of a gas sensor according to Modified Example 4; and

FIG. 12 is an exploded perspective view of a gas sensor according to Modified Example 5.

### DESCRIPTION OF EMBODIMENTS

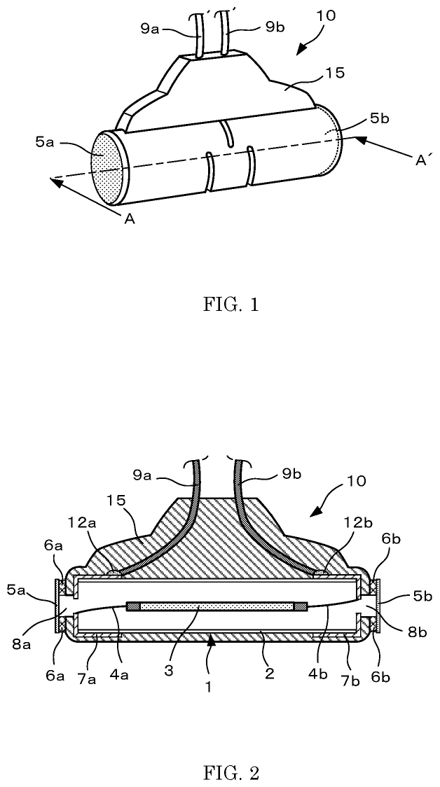

An embodiment according to the present invention is described in detail below with reference to accompanying drawings. FIG. 1 is an external perspective view of a gas sensor according to the embodiment of the present invention, and FIG. 2 is a cross-section of the gas sensor of FIG. 1 when cut along a line indicated by arrows A-A′. Note that while an oxygen sensor is given as an example as the gas sensor herein, a gas sensor having another gas besides oxygen as a detection target may also be used.

As illustrated in FIG. 1 and FIG. 2, a gas sensor 10 according to the embodiment ensures waterproof property etc. by having a structure in which an oxygen sensor 1 is covered (coated) in its entirety with an exterior material 15 made of heat resistant resin such as polyurethane, and in which air holes 8a and 8b formed in either end part of the oxygen sensor 1 are covered with waterproof cloths 5a and 5b, which are filter members acting as air permeable filters and waterproofing members. The waterproof cloths 5a and 5b are gas-permeable films made of GORE-TEX (®) etc., for example.

Here, from the viewpoint that good adherence is obtained if the exterior material and the adhesive are constituted of the same material, for example, urethane resin adhesives 6a and 6b, which are the same resin as the exterior material 15, are applied to outer circumferential edges of the air holes 8a and 8b so as to attach the waterproof cloths 5a and 5b to cover the air holes 8a and 8b. For example, vinyl chloride resin adhesive, epoxy resin adhesive, silicone resin adhesive etc. may be used as an adhesive with excellent water resistance.

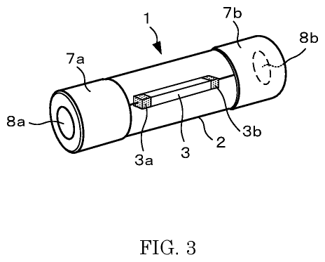

FIG. 3 is an external perspective view of the oxygen sensor 1. The oxygen sensor 1 has a structure in which an oxygen sensor element 3 is housed inside a cylindrical glass tube 2, which is made of heat-resistant glass, for example. The oxygen sensor element 3 is made from a ceramic sintered body, and the central portion thereof generates heat of a high temperature of approximately 900° C. when being connected to a power source and thereby receiving an electric current, wherein a local heat generating portion (also referred to as hot spot) will be an oxygen concentration detector.

That is, the oxygen sensor element 3 is a self-heating sensor not requiring a heater, allowing generation of a hot spot when electric power is supplied. Electric current flowing through the oxygen sensor element 3 is dependent on the oxygen concentration in the atmosphere where the sensor element is placed.

Metal conductive caps (also referred to as mouthpieces) 7a and 7b made of copper (Cu) etc. are fit on either end of the glass tube 2. Moreover, electrodes 3a and 3b made of a silver (Ag) paste, for example, are formed on either end part of the oxygen sensor element 3, and the electrodes are electrically connected to the respective conductive caps 7a and 7b via silver wires 4a and 4b.

The oxygen sensor element 3 is arranged such that the longitudinal direction of the oxygen sensor element 3 is in the axis direction of the glass tube 2 so as not to touch the glass tube 2. It also has a structure in which air holes 8a and 8b are formed in respective end surfaces (bottom surfaces) of the conductive caps 7a and 7b, and in which the oxygen sensor element 3 within the glass tube 2 is easily exposed to a concentration measuring target (oxygen) flowing through the air holes 8a and 8b.

In addition, power cables 9a and 9b, which supply electric power to the oxygen sensor element 3 and connect an ammeter for detecting oxygen concentration measurement results as electric current values, are soldered (indicated by references 12a and 12b) on the respective conductive caps 7a and 7b. This secures mechanical and electrical connections between the oxygen sensor 1 and the power cables 9a and 9b.

The outer dimensions (size) of the oxygen sensor 1 include, for example, a glass tube diameter of 5 mm, glass tube length of 20 mm, and air hole diameter of 2.5 mm. Moreover, the oxygen sensor element 3 has a length of 5 mm, for example. Such dimensions make the oxygen sensor element exchangeable via the air holes of the glass tube. The diameter of the air holes may be the same as or smaller than the dimensions given above in order to reduce excessive wind inflow to the glass tube.

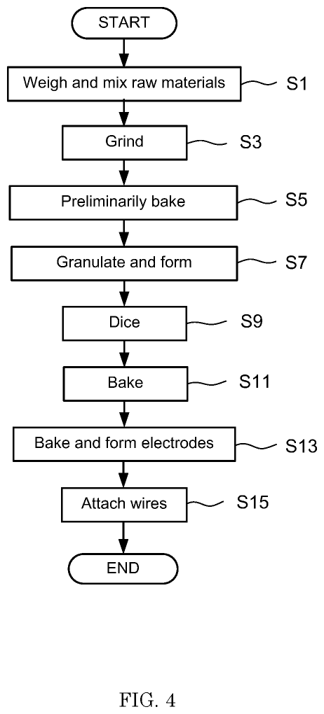

A manufacturing method of the gas sensor according to the embodiment is described next. A manufacturing method of the oxygen sensor element constituting the gas sensor is described first. FIG. 4 is a flowchart showing manufacturing steps of the oxygen sensor element in time series.

The oxygen sensor element 3 is a ceramic sintered body made of an oxide superconductor including a rare earth element such as LnBa₂Cu₃O_{7-δ}, for example. In Step S1 of FIG. 4, oxygen sensor element raw materials such as Y₂O₃, La₂O₃, BaCO₃, CaCO₃, and CuO are weighed using an electronic analytical scale etc. and mixed together so as to make a predetermined composition.

Ln (rare earth element) of the oxygen sensor element materials is Sc (scandium), Y (yttrium), La (lanthanum), Nd (neodymium), Sm (samarium), Eu (europium), Gd (gadolinium), Dy (dysprosium), Ho (holmium), Er (erbium), Tm (thulium), Yb (ytterbium), or Lu (lutetium), etc., and δ represents oxygen defect (0-1) in the above composition LnBa₂Cu₃O_{7-δ}.

In Step S3, the raw materials of the oxygen sensor element weighed and mixed together in Step S1 are ground using a ball mill. Grinding may also be carried out using a solid phase method or a liquid phase method, such as with a bead mill using grinding media as beads. In subsequent Step S5, the material (raw material powder) ground as described above is heat processed (preliminary baking) in the atmosphere at 900° C. for 5 hours, for example. Preliminary baking adjusts reactivity and grain size.

Next, in Step S7, an aqueous solution or the like of a binder resin (e.g., polyvinyl alcohol (PVA)) is added to the preliminarily baked mixture so as to make a granulated powder, and a pressing pressure is then applied on the granulated powder and molded. Here, a sheet member (press-molded body) having a thickness of 300 μm, for example, is manufactured. Note that molding may be carried out by a hydrostatic pressing method, hot pressing method, doctor blade method, printing method, or thin film method.

Dicing is carried out in Step S9. That is, the molded sheet member is cut into a predetermined product size and shape (e.g., 0.3×0.3×7 mm linear shape). Note that the smaller the size and diameter of the oxygen sensor element, the more excellent in electric power saving, and thus the product size may be different from the size mentioned above.

In Step S11, the oxygen sensor element that has been diced is baked in atmospheric air at, for example, 920° C. for 10 hours. Note that while the firing temperature may be 900 to 1000° C., the firing temperature may be changed according to composition since optimum temperature varies according to composition. In addition, de-binding may be performed before baking.

In Step S13, both ends of the resulting oxygen sensor element are clipped and coated in sliver (Ag), and dried at 150° C. for 10 minutes, thereby forming electrodes. In Step S15, a silver (Ag) wire 0.1 mm in diameter, for example, is attached through a joining method such as wire bonding to the electrodes formed in Step S13 described above and then dried at 150° C. for 10 minutes. Note that the terminal electrodes may be baked at a predetermined temperature after drying.

The electrodes and the wire material described above may be of a material other than silver (Ag), such as gold (Au), platinum (Pt), nickel (Ni), tin (Sn), copper (Cu), resin electrode, etc. Moreover, for forming the electrodes, a printing method or a film adhering method such as sputtering may be used. Furthermore, electrical characteristics of the oxygen sensor element manufactured through the steps described above may also be evaluated using a four-terminal method, for example, as a final step in FIG. 4.

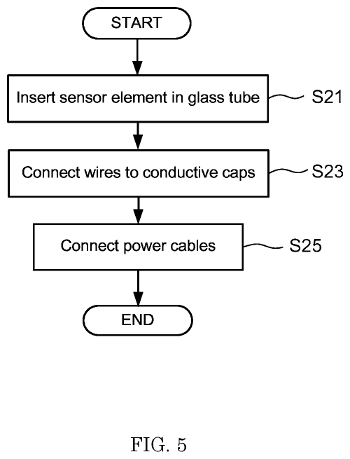

FIG. 5 is a flowchart showing, in time series, the steps of manufacturing the oxygen sensor using the oxygen sensor element manufactured using the method shown in FIG. 4. In Step S21 of FIG. 5, the oxygen sensor element 3 is inserted in the glass tube via the air holes 8a and 8b of the conductive caps 7a and 7b covering either end of the glass tube 2 (see FIG. 3).

In Step S23, the silver wires 4a and 4b extending from the electrodes on either end part of the oxygen sensor element 3 are connected to the respective conductive caps 7a and 7b through soldering etc. Then in Step S25, the power cables 9a and 9b are connected to the respective conductive caps 7a and 7b through soldering etc. This secures electrical connections between the silver wires 4a and 4b and the respective power cables 9a and 9b.

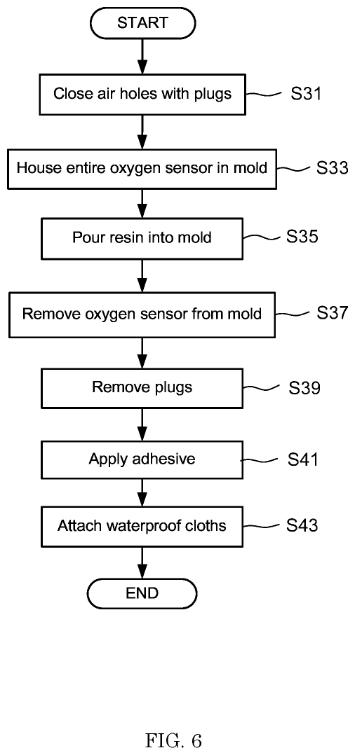

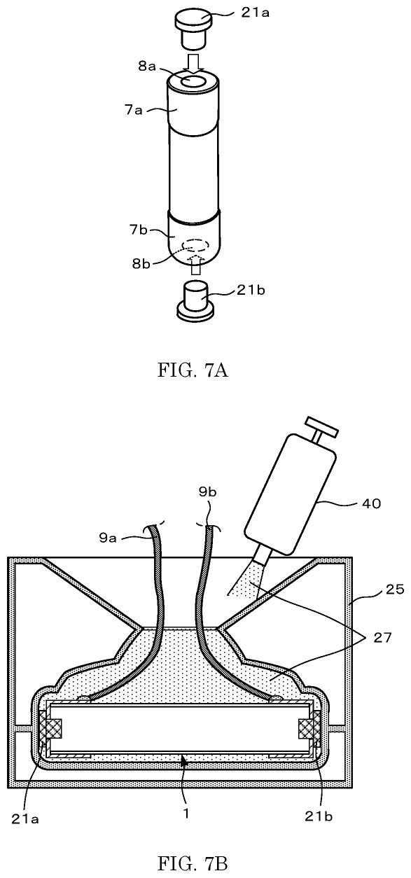

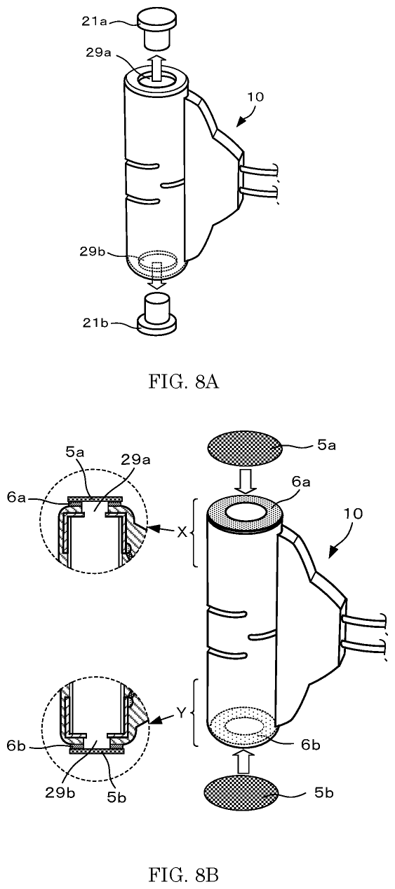

FIG. 6 is a flowchart showing, in time series, manufacturing steps of the gas sensor according to the embodiment. FIGS. 7A, 7B, 8A and 8B show diagrams for explaining the manufacturing steps of the gas sensor. In Step S31 of FIG. 6, plugs 21a and 21b are inserted into the respective air holes 8a and 8b, as illustrated in FIG. 7A, such that the air holes of the oxygen sensor are not closed by resin when applying a resin coating described later.

In Step S33, the oxygen sensor 1 having the air holes plugged is housed in its entirety in a mold 25 made of metal or resin etc., as illustrated in FIG. 7B. Then in Step S35, an insulative resin 27 such as polyurethane is poured in the mold 25 using a resin injector 40 or the like, for example, thereby applying an insulative coating to the oxygen sensor 1 and the power cables 9a and 9b.

Once the insulative resin 27 is hardened, the oxygen sensor 1 is taken out of the mold 25 in Step S37, and in subsequent Step S39, the plugs 21a and 21b inserted in the air holes 8a and 8b before application of the insulative coating are removed, as illustrated in FIG. 8A. Removal of the plugs forms openings 29a and 29b that connect to the air holes 8a and 8b of the oxygen sensor 1, to which the insulative coating is applied, in the gas sensor 10.

In Step S41, the same kind of urethane resin adhesives 6a and 6b as the exterior material 15 are applied to the outer circumferential edges of the air holes 29a and 29b, as illustrated in FIG. 8B. Then in Step S43, the waterproof cloths 5a and 5b, which are air permeable filter members cut out in a predetermined size, are attached so as to cover the openings 29a and 29b. In dotted-line circles of FIG. 8B are cross-sectional block diagrams of an X part and a Y part of the gas sensor 10, illustrated showing the waterproof cloths 5a and 5b attached using the resin adhesives 6a and 6b so as to cover the respective openings 29a and 29b.

Note that when applying the insulative coating to the oxygen sensor 1 and the power cables 9a and 9b, a dipping method without use of a mold may be used. Any mold being unnecessary allows simplification of the manufacturing steps and low-cost coating. Moreover, the gas sensor 10 may have a structure in which an insulative coating is applied to at least the conductive caps 7a and 7b without coating the oxygen sensor 1 in its entirety, thereby exposing glass portions. This also ensures waterproof property.

Alternatively, while omitted from the drawings, the gas sensor 10 of FIG. 1 etc. may also have a structure in which net-like members are attached to the outer sides of the waterproof cloths 5a and 5b, which act as filter members covering the respective air holes 8a and 8b and the respective openings 29a and 29b. The net-like members thus prevent invasion of dust etc. coming flying together with gas to be measured. Furthermore, a structure in which only one of the openings of the gas sensor 10 is covered with a waterproof cloth is possible.

Inspection results of insulating property etc. of the gas sensor according to the embodiment having the structure described above are described next. Table 1 gives the results of comparing insulating property etc. of the gas sensor according to the embodiment, to which the insulative coating is applied, with those of the conventional sensor element without an insulative coating, both in the air and in saline solution. With the gas sensor of the embodiment, a coating of polyurethane resin is applied using a mold according to Working Example 1 while the coating of polyurethane resin is applied through clipping according to Working Example 2.

TABLE 1

| | Electric resistance | | Insulating |
|---|---|---|---|
| | In air | In saline solution | property |
| Working Example 1 | 1 GΩ or greater | 1 GΩ or greater | Good |
| Working Example 2 | 1 GΩ or greater | 1 GΩ or greater | Good |
| Conventional | 1 GΩ or greater | Several kΩ | Poor |
| Example | | | |

Here, the sensor element is set in an OPEN state in order to evaluate insulating property etc. between external electrodes and the solution as a result of the coating structure. As a result of the evaluation, it is found that while the hot spot of a sensor element according to a conventional example shows decrease in insulating property in the saline solution, the hot spot of the sensor element according to Working Examples 1 and 2 shows that sufficient insulating property is ensured even in the saline solution.

That is, the gas sensor (hot spot-type oxygen sensor) according to the embodiment to which an insulative coating is applied and in which the openings are covered with waterproof cloths with air permeability is able to maintain sensor characteristics without losing the hot spot even when it is operated as a gas sensor in a saline solution. In contrast, the conventional sensor to which an insulative coating is not applied loses its sensor characteristics since a saline solution penetrates inside of the case housing the sensor element.

As described above, use of a structure in which an insulative coating of an insulative resin (exterior resin material) is applied to the oxygen sensor made up of a self-heating oxygen sensor element housed in a case, and in which the openings connected to the air holes in the case end parts are covered with waterproof cloths with air permeability allows the gas sensor for use both in air and in liquid to have insulating property, waterproof property, and thermal safety.

That is, with the structure in which the metal electrode caps provided on the end parts of the oxygen sensor are not exposed to the outside in the gas measurement environment, the electric current flowing through the oxygen sensor does not leak out via the electrode caps in a conducting material or liquid, such as water, sea water, concrete, or a culture solution. For that reason, detection of gas concentration according to accurate sensor output is possible in both environments of air and liquid as the atmosphere to be measured.

Moreover, since the waterproof cloths are attached to the exterior resin material using a resin adhesive similar to the exterior resin material, a stronger connectivity between the waterproof cloths and the exterior resin material may be ensured.

Furthermore, the waterproof cloths, which are adhered so as to cover the openings connecting to the air holes of the oxygen sensor, have a waterproof effect as well as effect of not letting wind blow directly against the oxygen sensor element that is arranged inside of a glass pipe. As a result, the oxygen sensor, which includes a heating part of the oxygen sensor element as an oxygen concentration detector, can prevent the sensor element from losing heat due to the wind and prevent the oxygen detection performance from degrading, resulting in accurate measurement of oxygen concentration in the atmosphere to be measured.

The gas sensor of the present invention is not limited to the embodiment described above, and various modifications are possible. Modified examples of the embodiment are described next.

### Modified Example 1

According to the embodiment described above, the plugs 21a and 21b are inserted in the respective air holes 8a and 8b of the oxygen sensor 1, and once the insulative resin 27 poured in the mold 25 is hardened, the plugs are removed, and the waterproof cloths 5a and 5b are attached with the resin adhesives 6a and 6b so as to cover the openings 29a and 29b, which communicate with the respective air holes 8a and 8b. However, method of attaching the waterproof cloths 5a and 5b is not limited hereto.

For example, before applying the insulative coating, arrange the oxygen sensor element 3 in the glass pipe 2, and connect the silver wires 4a and 4b of the oxygen sensor element 3 to the respective conductive caps 7a and 7b, and at the same time, prepare an oxygen sensor 31 to which the waterproof cloths 5a and 5b are attached so as to cover the air holes 8a and 8b. Then, place the entire oxygen sensor 31 in a mold 35 illustrated in FIG. 9, with protrusions 35a and 35b, which are provided in positions facing the respective air holes 8a and 8b, touching the respective outer sides of the waterproof cloths 5a and 5b.

The insulative resin 27, such as polyurethane, is then poured into the mold 35, applying an insulative coating to the oxygen sensor 31 and the power cables 9a and 9b. As a result, the waterproof cloths 5a and 5b may be fixed to the respective air holes 8a and 8b of the oxygen sensor 31, to which the insulative coating is applied, using a part of the insulative resin 27 so as to cover the air holes 8a and 8b, resulting in a gas sensor having waterproof property, etc. for use both in air and in liquid. Even in this case, a structure in which only one of the air holes of the oxygen sensor 1 is covered with a waterproof cloth may be used.

### Modified Example 2

In place of the metal conductive caps 7a and 7b fitted on a storage case (glass pipe) of the oxygen sensor element 3 as described above, while omitted from the drawings, a structure in which caps made of resin including air holes are arranged on either end part, and in which electrode wires leading from the end parts of the oxygen sensor element are directly connected to the power cables may be used. Since there are no metal electrodes (caps), leakage of an electric current flowing through the oxygen sensor to the outside via the caps may be inhibited.

### Modified Example 3

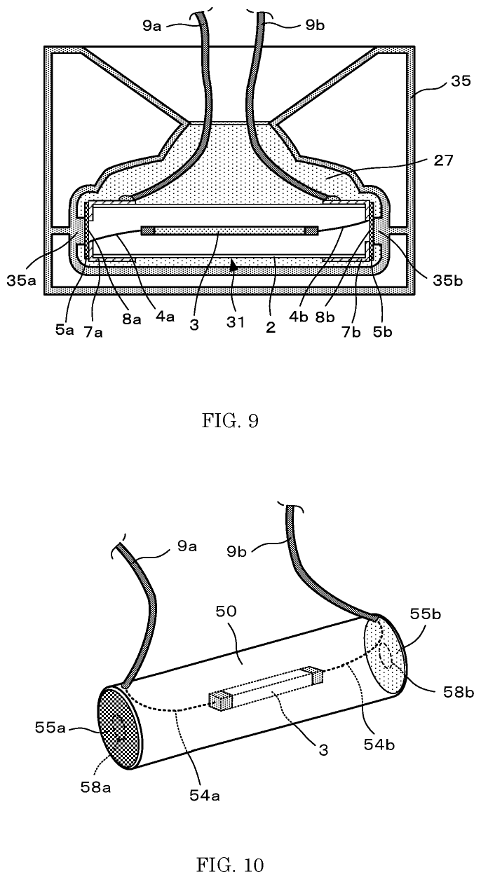

The storage part (storage case) of the oxygen sensor element 3 of the oxygen sensor 1 is not limited to a glass pipe, and may be a cylindrical member having insulating property and heat-resisting property, for example. More specifically, as illustrated in FIG. 10, it is a gas sensor having a structure integrated in a cylindrical member 50 having insulating property and heat-resisting property, wherein air holes 58a and 58b are formed in either end part without providing caps. Waterproof cloths 55a and 55b with air permeability are then attached so as to cover the air holes 58a and 58b, respectively.

The gas sensor has a capless structure in this manner, and the structure having electrode wires 54a and 54b, which lead from the end parts of the oxygen sensor element 3 and are directly connected to the power cables 9a and 9b, can inhibit leakage of an electric current flowing through the oxygen sensor element to the outside via the electrodes (caps). Moreover, since the oxide sensor does not need to be covered with an insulative resin (exterior resin material), manufacturing cost can be reduced.

### Modified Example 4

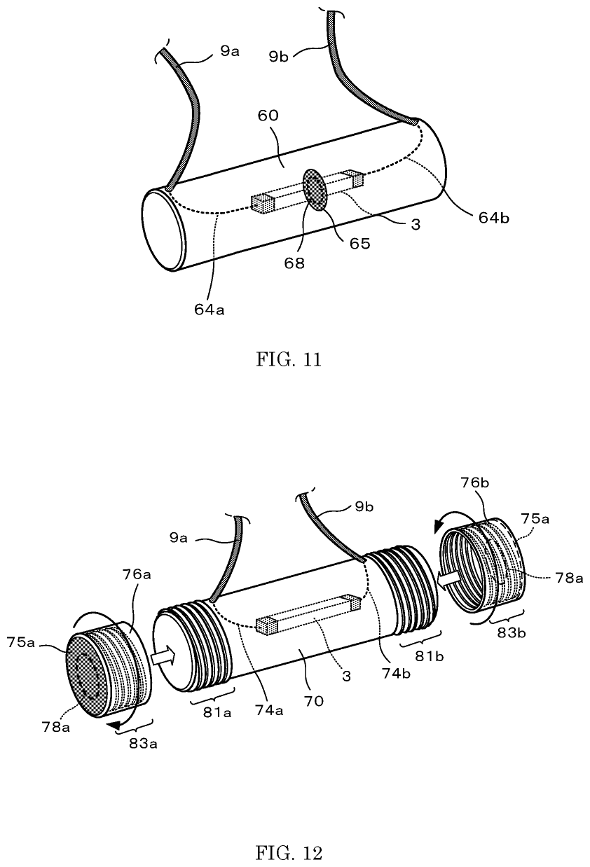

A gas sensor illustrated in FIG. 11 is an example also having a capless structure. However, different from Modified Example 3 of FIG. 10, the sensor has a structure where air holes are not formed in either end of a cylindrical member 60 having insulating property and heat-resisting property. That is, an air hole 68 is provided near the central part of the oxide sensor element 3 and in the central part of the cylindrical member 60, and a waterproof cloth 65 with air permeability is attached so as to cover the air hole 68.

Even in the example illustrated in FIG. 11, electrode wires 64a and 64b leading from the end parts of the oxygen sensor element 3 are directly connected to the respective power cables 9a and 9b, thereby inhibiting leakage of an electric current flowing through the oxygen sensor element to the outside via the electrodes (caps). Moreover, since the oxide sensor of Modified Example 4 also does not need to be covered with an insulative resin (exterior resin material), manufacturing cost can be reduced.

### Modified Example 5

FIG. 12 illustrates a gas sensor having a structure including detachable caps 76a and 76b having the same insulating property and heat-resisting property as those of a cylindrical member 70. Male screws 81a and 81b having a predetermined pitch have screw threads in either end part of the cylindrical member 70. Moreover, female screws 83a and 83b having a pitch matching the pitch of the male screws 81a and 81b have screw threads in inner walls of the caps 76a and 76b.

Furthermore, air holes 78a and 78b are formed in respective end surfaces (bottom parts) of the caps 76a and 76b, and waterproof cloths 75a and 75b with air permeability are attached so as to cover the air holes 78a and 78b. Rotating the caps 76a and 76b in arrow directions of FIG. 12 while pressing them on the end parts of the cylindrical member 70 screws the caps 76a and 76b into the cylindrical member 70. As a result of such screwing in, insulating property and heat-resisting property etc. are provided, providing a gas sensor for use both in air and in liquid having permeable waterproof films on either end of the cylindrical member 70.

Since the oxide sensor illustrated in FIG. 12 includes electrode wires 74a and 74b leading from the end parts of the oxygen sensor element 3, which are directly connected to the respective power cables 9a and 9b, and the caps are electrically insulative, it can inhibit leakage of an electric current flowing through the oxygen sensor element to the outside via the caps. Moreover, since the oxide sensor does not need to be covered with an insulative resin (exterior resin material), manufacturing cost can be reduced. Furthermore, use of a structure having the caps 76a and 76b in a screw-type detachable form allows exchange of the whole caps when the waterproof cloths 75a and 75b are deteriorated, contaminated, etc.

### DESCRIPTION OF REFERENCES

1, 31: Oxygen sensor
2: Glass tube
3, 10, 11: Oxygen sensor element
3a, 3b: Electrode
4a, 4b, 54a, 54b, 64a, 64b: Silver wire
5a, 5b, 55a, 55b, 75a, 75b: Waterproof cloth
6a, 6b: Resin adhesive
7a, 7b: Conductive cap (mouthpiece)
8a, 8b, 58a,58b, 78a,78b: Air hole
9a, 9b: Power cable
10: Gas sensor
15: Exterior material
21a, 21b: Plug
25, 35: Mold
27: Insulative resin
29a, 29b: Opening
35a, 35b: Protrusion
50, 60: Cylindrical member
76a, 76b: Cap
81a, 81b: Male screw
83a, 83b: Female screw

1. A gas sensor, comprising:
a gas sensor element housed in a case having air holes;
an insulative exterior member sealing the case while having openings that communicate with the air holes;
a filter member arranged so as to cover the entire openings; and
paired lead wires, which are connected to end part electrodes of the gas sensor element and lead outside the exterior member; wherein
a predetermined gas permeating through the filter member is detected by the gas sensor element.

2. The gas sensor according to claim 1, wherein the filter member is a permeable film that prevents a specified gas from permeating through.

3. The gas sensor according to claim 1, wherein the filter member is a permeable waterproof film.

4. The gas sensor according to claim 1, wherein the gas sensor element is a self-heating sensor element made of a ceramic sintered body.

5. The gas sensor according to claim 1, wherein the exterior member is a urethane resin material.

6. The gas sensor according to claim 5, wherein the filter member is attached using a urethane resin adhesive that is applied to circumferential edges of the openings.

7. The gas sensor according to claim 1, wherein the exterior member is formed so as to cover at least electrodes provided on the end parts of the case.

8. The gas sensor according to claim 7, further comprising a structure in which a first layer of the exterior member made of the urethane resin material, and a second layer made of the urethane resin adhesive are provided between the electrodes and the filter member.

9. A manufacturing method of a gas sensor housing a gas sensor element in a case having air holes, comprising the steps of:
closing the air holes using plug members;
sealing the case, in which the air holes are closed, with an insulative exterior member;
removing the plug members from the air holes once the exterior member is hardened; and
attaching filter members so as to cover entire openings that communicate with the air holes formed in portions where the plug members have been removed.

10. The manufacturing method of a gas sensor according to claim 9, wherein the exterior member is formed so as to cover at least electrodes provided on end parts of the case.
